(19) United States
(12) Patent Application Publication
(10) Pub. No.: US 2002/0118402 A1
(43) Pub. Date: Aug. 29, 2002

(54) Film bridge for digital film scanning system

(76) Inventors: Timothy C. Shaw, Austin, TX (US); William D. Mapel, Liberty Hill, TX (US); Matthew R. Thomas, Austin, TX (US)

Correspondence Address: DINSMORE & SHOHL, LLP, 1900 CHEMED CENTER, 255 EAST FIFTH STREET, CINCINNATI, OH, 45202, US

(21) Appl. No.: 09/955,574

(22) Filed: Sep. 18, 2001

Related U.S. Application Data
(60) Provisional application No. 60/233,842, filed on Sep. 19, 2000.

(51) Int. Cl. H04N 1/04

(52) U.S. Cl. 358/474

(57) ABSTRACT

Film support bridges for use in precisely positioning film during scanning in a digital film processing system. A friction reducing material may be applied to the bridge to minimize scratching of the film. The material may be applied to only the center portion of the bridge to raise the film at its center but to allow the edges of the film near the sprocket holes to be free from contact with the bridge to minimize vibration. In other embodiments, the bridge includes a pair of longitudinally spaced rollers which roll as the film travels over the bridge, the bridge includes a pair of transversely spaced side rollers which contact the film near the side edges of the film, or the bridge comprises two elongated strips which are connected near their ends so as to form an elongated slot which has a length less than the width between sprocket holes.

This application claims the benefit of U.S. Provisional Application No. 60/233,842 filed Sep. 19, 2000, the entire disclosure of which is hereby incorporated herein by reference.

### TECHNICAL FIELD

The present invention relates generally to film scanning, and more particularly to a film bridge for use in the transportation and scanning of film in a film scanning system.

### BACKGROUND OF THE INVENTION

Color photographic film generally comprises three layers of light sensitive material that are separately sensitive to red, green, and blue light. During conventional color photographic film development, the exposed film is chemically processed to produce dyes in the three layers with color densities directly proportional to the blue, green and red spectral exposures that were recorded on the film in response to the light reflecting from the photographed scene. Yellow dye is produced in the top layer, magenta dye in the middle layer, and cyan dye in the bottom layer, the combination of the produced dyes revealing the latent image. Once the film is developed, a separate printing process can be used to record photographic prints, using the developed film and photographic paper.

In contrast to conventional film development, digital film development systems, or digital film processing systems, have been proposed. One such system involves chemically developing exposed film to form scene images comprised of silver metal particles or grains in each of the red, green, and blue recording layers of the film. Then, while the film is developing, it is scanned using electromagnetic radiation, such as light with one predominant frequency, preferably in the infrared region. In particular, as the film develops in response to chemical developer, a light source is directed to the front of the film, and a light source is directed to the back of the film. Grains of elemental silver developing in the top layer (e.g., the blue sensitive layer) are visible from the front of the film by light reflected from the front source; however, these grains are substantially hidden from the back of the film. Similarly, grains of elemental silver developing in the bottom layer (e.g., the red sensitive layer) are visible from the back of the film by light reflected from the back source; however these grains are substantially hidden from the front. Meanwhile, grains of elemental silver in the middle layer (e.g., the green sensitive layer) are substantially hidden from the light reflected from the front or back; however, these grains are visible by any light transmitted through the three layers, as are those grains in the other two layers. Thus, by sensing, for each pixel location, light reflected from the front of the film, light reflected from the back of the film, and light transmitted through the film, three measurements can be acquired for each pixel. The three measured numbers for each pixel can then be solved for the three colors to arrive at three color code values for each pixel, and the plurality of colored pixels can then be printed or displayed to view the image.

If desired, such scanning of each frame on the film can occur at multiple times during the development of the film. Accordingly, features of the frame which may appear quickly during development can be recorded, as well as features of the frame which may not appear until later in the film development. The multiple digital image files for each frame can then be combined to form a single enhanced image file.

In another such digital film processing system, a developer solution is applied to the film and dyes form on the film. As the film is developing via the applied solution, visible light and/or infrared light are applied to one side of the film. On the opposite side of the film, a sensor detects the light passing through the film and produces a digital representation of the image developing on the film.

With these and other digital film processing and scanning systems, the film can be moved across a scanning area, and the radiation can be applied to the scanning area to obtain the image data. A film bridge or similar support mechanism can be utilized to control the position of the film as it passes over the scanning area. For optimum accuracy in scanning of the film, the positioning of the film should be tightly controlled. In particular, vertical vibration and movement of the film should be avoided as such movements can jolt the film out of the focus of the optics, resulting in unfocused image data. Moreover, the film should remain substantially flat across the imaging area in order to obtain accurate results. In addition, the mechanisms used to transport and control the position of the film during scanning should avoid imparting scratches or other physical defects to the image area of the film, as such scratches and defects can result in an inferior digital image.

According, there is a need for film positioning mechanisms which tightly control the position of film during scanning, and/or which minimize imparting scratches or physical defects to the image area of the film.

### SUMMARY OF THE INVENTION

According to one aspect of the invention, a film bridge for a digital film scanning system is provided comprising a first bridge member having a film facing surface to support moving photographic film, and a second bridge member having a film facing surface to support moving photographic film. The bridge members are spaced so as to define an opening between the bridge members for passing radiation through film traveling over the film facing surfaces. The bridge members can comprise a pair of spaced rigid strips and the opening can comprise a slot defined between the strips. A friction reducing material can be applied to a portion of the film facing surface of at least one of the strips to provide a smooth film travel surface. In one exemplary embodiment, the material has a length less than the width of the film between the sprocket holes, so as to avoid contact of the bridge and sprocket hole areas. The bridge members could alternatively comprise a pair of rollers spaced longitudinally in the film travel direction. Preferably, the length of these rollers is less than the width of the film between the sprocket holes to avoid contact with the sprocket hole areas. As another alternative, the bridge members could comprise a pair of transversely spaced side rollers, which preferably contact the edge portions of the film outside of the sprocket holes. In another embodiment, no material is applied to the bridge member, but the slot defined by the member (through which the scanning light passes) has a length less than the width of the film between the sprocket holes. In this way, the sprocket holes do not pass over the slot but travel smoothly over continuous end portions of the bridge, producing less movement of the film during scanning.

According to another aspect of the invention, a digital film processing system is provided comprising a source configured to apply radiation to developing film, and a sensor configured to sense transmitted and reflected radiation from developing film. The system also includes a film bridge configured to support developing film without contacting the sprocket holes of the developing film. The digital film processing system can sense radiation from the front and back of the film in a duplex film scanning process to create a digital image of a frame on the film. Digital images for a frame can be created at multiple film development times and combined to form a single enhanced digital image for the frame. Alternatively, the digital film processing system can sense visible and infrared radiation transmitted through the film in one direction at a single development time.

An advantage of at least one embodiment of the invention is that the positioning of film is tightly controlled as it is transported and scanned.

One advantage of at least one embodiment of the invention is that the magnitude and frequency of defects which are applied to the film during film transportation are reduced.

The above advantages are provided merely as examples, and are not limiting nor do they define the present invention or necessarily apply to every aspect thereof. Still other advantages of various embodiments will become apparent to those skilled in this art from the following description wherein there is shown and described exemplary embodiments of this invention simply for the purposes of illustration. As will be realized, the invention is capable of other different aspects and embodiments without departing from the scope of the invention. Accordingly, the advantages, drawings, and descriptions are illustrative in nature and not restrictive in nature.

### BRIEF DESCRIPTION OF THE DRAWINGS

While the specification concludes with claims particularly pointing out and distinctly claiming the invention, it is believed that the same will be better understood from the following description taken in conjunction with the accompanying drawings in which like reference numerals indicate corresponding structure throughout the figures.

FIG. 1 is a perspective view of an exemplary embodiment of a digital film development system which can be used with the methods and apparatus of the present invention;

FIG. 2 illustrates an exemplary operation of the digital film development system of FIG. 1;

FIG. 3 is a side view of an exemplary modular digital film development system having multiple scanning stations or modules which can be used with film bridge embodiments of the present invention;

FIG. 4 is a perspective view of an exemplary embodiment of a modular digital film development system, which can be utilized with film bridge embodiments of the present invention;

FIG. 5 is a side view of the digital film development system of FIG. 4;

FIG. 6 is a perspective view of an exemplary arcuate film transportation and guidance assembly for use in a digital film development system, and including an exemplary film bridge made in accordance with principles of the present invention;

FIG. 7 is a partially-exploded perspective view of an alternative embodiment of a film transportation and guidance assembly for use in a digital film development system, and including an exemplary film bridge made according to principles of the present invention;

FIGS. 8 and 9 are top perspective views of exemplary embodiments of arcuate film bridges having friction reducing material for use in supporting film in a digital film developments system, according to principles of the present invention;

FIG. 10 is a cross-section view of the exemplary film bridge of FIG. 8;

FIG. 11 is an exemplary graph illustrating film position control which can be achieved by the exemplary film bridge embodiment of FIG. 8;

FIG. 12a and FIG. 12b are top perspective views of exemplary embodiments of dual roller film bridges, made according to principles of the present invention;

FIG. 13 is a perspective view of an exemplary digital film processing module utilizing the exemplary dual roller film bridge of FIG. 12a;

FIG. 14 is a cross-sectional view of the exemplary film bridge of FIG. 12a, taken along line 14;

FIG. 15 is a cross-sectional view of the exemplary film bridge of FIG. 12a, taken along line 15;

FIG. 16 is an exemplary graph illustrating film position control which can be achieved by the embodiment of FIG. 12a;

FIG. 17 is a perspective view of an exemplary side roller film bridge for supporting film edges during scanning, according to another aspect of the present invention;

FIG. 18 is a front view of the exemplary embodiment of FIG. 17;

FIG. 19 is a cross-sectional view of the exemplary embodiment of FIG. 17;

FIG. 20 is a perspective view of another exemplary side roller film bridge for supporting film edges during scanning, according to principles of the present invention;

FIG. 21 is an exemplary graph illustrating film position control which can be achieved by the embodiment of FIG. 17;

FIG. 22 is a cross-sectional view of the exemplary embodiment of FIG. 8 taken along line 22-22; and

FIG. 23 is top view of an exemplary film bridge having a slot which is narrower than the width between sprocket holes, in accordance with principles of the present invention.

### DETAILED DESCRIPTION OF PREFERRED EMBODIMENTS

The present invention relates to film support bridges for use in supporting film during scanning in a film scanning system. In one embodiment, the film bridge includes a pair of spaced, arcuate members which support the film during scanning. In this embodiment, friction reducing material, such as a low friction material, is applied to the members to prevent scratches being imparted to the film during movement of the film during scanning. The material may be applied to only the center portion of the members to raise the film at its center but to allow the edges of the film near the sprocket holes to be free from contact with the bridge. (Contact between the film and bridge near the sprocket holes can cause vibration during film transportation due to distortion near the sprocket holes, which can result in less accurate scanning data.) In another embodiment, the bridge includes a pair of longitudinally spaced rollers which roll as the film travels over the bridge. The length of each roller can be less than the width of the film between the sprocket holes, so that the edges of the film near the sprocket holes are free from contact with the bridge. In another embodiment, the bridge includes a pair of transversely spaced side rollers which contact the film near the side edges of the film. These side rollers can contact the film outside of the film sprocket holes. In another embodiment, the film bridge comprises two elongated strips which are connected near their ends so as to form an elongated slot which allows the scanning light to pass through the film. The length of the slot is less than the width of the film between sprocket holes such that the sprocket holes do not pass over the slot but are supported by the continuous ends of the bridge. Passing sprocket holes over the slot can cause undesirable movement of the film during scanning.

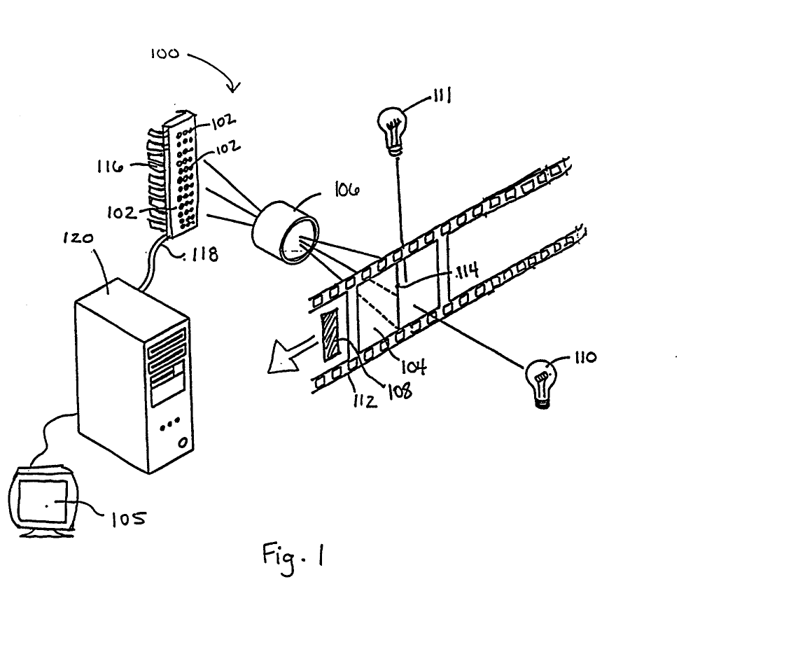

FIG. 1 shows an exemplary digital film processing system 100. The system operates by converting electromagnetic radiation from an image to an electronic (digital) representation of the image. The image being scanned is typically provided on a photographic film media 112 which is being developed using chemical developer. In many applications, the electromagnetic radiation used to convert the image into a digital representation is infrared light; however, visible light, microwave and other suitable types of electromagnetic radiation may also be used to produce the digitized image. The scanning system 100 generally includes a number of optic sensors 102, which measure the intensity of electromagnetic energy passing through or reflected by the developing film 112. The source of electromagnetic energy is typically a light source 110 which illuminates the film 112 containing the scene image 104 and 108 to be scanned, which are forming on the film during the film development. Radiation from the source 110 may be diffused or directed by additional optics such as filters or waveguides (not shown) and/or one or more lenses 106 positioned between the sensor 102 and the film 112 in order to illuminate the images 104 and 108 more uniformly.

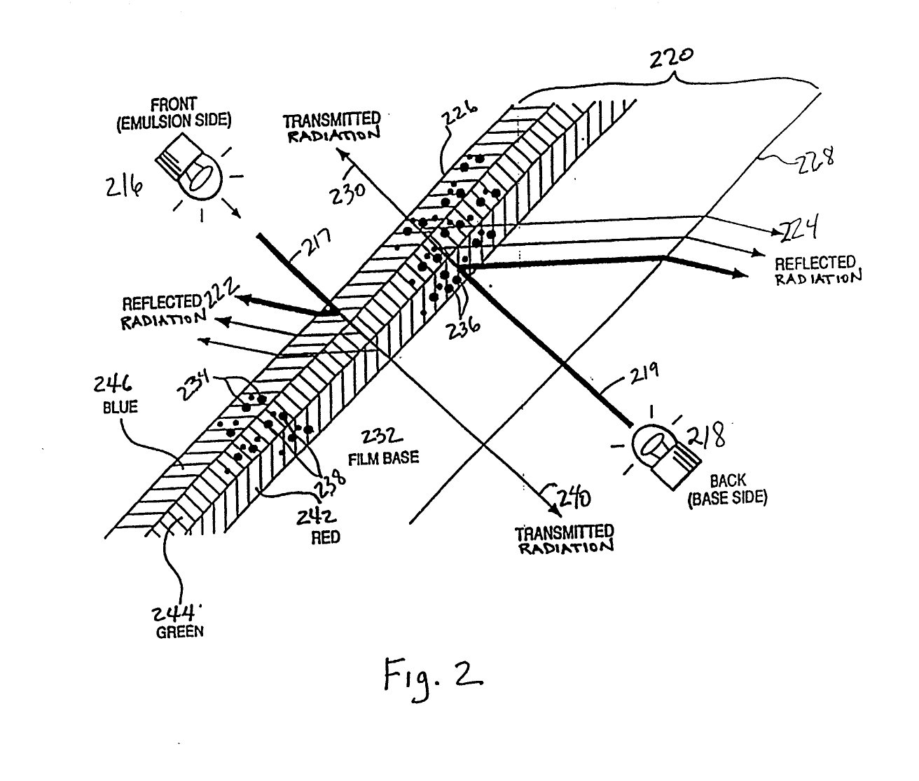

Source 110 is positioned on the side of the film 112 opposite the optic sensors 102. This placement results in sensors 102 detecting radiation emitted from source 110 as it passes through the images 104 and 108 on the film 112. Another radiation source 111 can be placed on the same side of the film 112 as the sensors 102. When source 110 is activated, sensors 102 detect radiation reflected by the images 104 and 108. This process of using two sources positioned on opposite sides of the film being scanned is referred to as duplex scanning and is described in more detail below in conjunction with FIG. 2.

The optic sensors 102 are generally geometrically positioned in arrays such that the electromagnetic energy striking each optical sensor 102 corresponds to a distinct location 114 in the image 104. Accordingly, each distinct location 114 in the scene image 104 corresponds to a distinct location, referred to as a picture element, or “pixel” for short, in a scanned image, or digital image file, which comprises a plurality of pixel data. The images 104 and 108 on film 112 can be sequentially moved, or scanned relative to the optical sensors 102. The optical sensors 102 are typically housed in a circuit package or unit 116 which is electrically connected, such as by cable 118, to supporting electronics for storage and digital image processing, shown together as computer 120. Computer 120 can then process the digital image data and display it on output device 105. Alternatively, computer 120 can be replaced with a microprocessor or controller and cable 118 replaced with an electrical connection.

Optical sensors 102 may be manufactured from different materials and by different processes to detect electromagnetic radiation in varying parts and bandwidths of the electromagnetic spectrum. For instance, the optical sensor 102 can comprise a photodetector that produces an electrical signal proportional to the intensity of electromagnetic energy striking the photodetector. Accordingly, the photodetector measures the intensity of electromagnetic radiation attenuated by the images 104 and 108 on film 112.

The embodiments of the present invention described in detail below can use duplex film scanning. As shown in FIG. 2, duplex scanning refers to using a front source 216 and a back source 218 to scan a developing film 220 with radiation 217 and 219 respectively. The applied radiation 217 and 219 results in reflected radiation 222 from the front 226 and reflected radiation 224 from the back 228 of the film 220, as well as transmitted radiation 230 and 240 that passes through all layers of the film 220. While the sources 216, 218 may emit a polychromatic light (i.e., multifrequency light), the sources 216, 218 preferably emit monochromatic light and most preferably infrared light. The resulting radiation 222, 224, 240, and 230 are referred to herein as front, back, front-through and back-through, respectively, and are further described below.

The scanning system 100 may comprise a number of different configurations depending, in part, on how the film 112 was developed. In an embodiment using visible light, specific colors of visible light interact with the dye images and any silver present in the film 112. In an embodiment using infrared light, the infrared light interacts with the silver in the film 112. The silver (metallic silver and/or silver halide) can also be modified to reduce the optical effects of the silver. For example, a bleaching agent may be applied to the film 112. The bleaching agent operates to oxidize the metallic silver grains within the film 112 to produce silver halide. The silver halide has a lower optical density than the metallic silver grains. As a result, a greater amount of light is transmitted through the film 112. Another example is a fixer agent. A fixer agent dissolves the silver halide to produce a silver compound that is substantially transparent to light. As a result, light is readily transmitted through the film 112.

As discussed above, the scanning system 100 scans the film 112 using electromagnetic radiation that is sensed by optical sensor 102 and produces image data representative of the image 104. In another embodiment of the scanning system, the film 112 is scanned with light within the visible portion of the electromagnetic Espectrum. The visible light measures the light intensity associated with the dye clouds as well as the silver within the film 112. In particular, one or more bands of visible light may be used to scan the film 112. For example, the film 112 may be scanned using visible light within the red, green and/or blue portions of the electromagnetic radiation spectrum. In other embodiments of the scanning system 100, the film 112 is scanned with visible light and infrared light, with different combinations of visible light, or any other suitable electromagnetic radiation. In general, the processing solutions are not substantially removed prior to scanning the film 112. In contrast, conventional film processing systems wash all the processing solutions and silver, both silver halide and metallic silver, from the film 112 prior to any conventional scanning processes. In such conventional systems, silver, whether metallic silver or silver halide crystals, in the film negative interferes with the transmission of light through the film negative and would be digitized along with the image.

In the embodiment of FIG. 2, separate color layers are viewable within the film 220 during development of the red layer 242, green layer 244 and blue layer 246. More specifically, over a clear film base 232 are three layers 242, 244, 246 sensitive separately to red, green, and blue light, respectively. These layers are not physically the colors; rather, they are sensitive to these colors. In conventional color film development, the blue sensitive layer 246 would eventually develop a yellow dye, the green sensitive layer 244 a magenta dye, and the red sensitive layer 242 a cyan dye.

During chemical development of the film 220, such as by using a developer, layers 242, 244, and 246 are opalescent. Dark silver grains 234 developing in the top layer 246, (the blue source layer), are visible from the front 226 of the film by reflected radiation 222, and slightly visible from the back 228 because of the bulk of the opalescent developer emulsion. Similarly, grains 236 in the bottom layer 242 (the red sensitive layer) are visible from the back 228 by reflected radiation 224, but are much less visible from the front 226. Grains 238 in the middle layer 244, the green sensitive layer, are only slightly visible to reflected radiation 222, 224 from the front 226 or the back 228. However, they are visible along with those in the other layers by transmitted radiation 230 and 240. By sensing radiation reflected from the front 226 and the back 228 as well as radiation transmitted through the developing film 220 from both the front 226 and back 228 of the film, each pixel in the film 220 yields four measured values, that may be mathematically solved for the three colors, red, green, and blue, closest to the original scene. For instance, a matrix transformation may be utilized as described in U.S. Pat. No. 5,519,510, the entire disclosure of which is hereby incorporated herein by reference.

The front signal records the radiation 222 reflected from the illumination sources 216 in front of the developing film 220. The set of front signals for an image is called the front channel (F). The front channel principally, but not entirely, records the attenuation in the radiation from the source 216 due to the silver metal particles 234 in the top-most layer 246, which is the blue recording layer. The front channel also records some attenuation in the radiation which is due to silver metal particles 238, 236 in the red and green layers 244, 242.

The back signal records the radiation 224 reflected from the illumination sources 218 in back of the developing film 220. The set of back signals for an image is called the back channel (B). The back channel principally, but not entirely, records the attenuation in the radiation from the source 218 due to the silver metal particles 236 in the bottom-most layer 242, which is the red recording layer. Additionally, there is some attenuation which is recorded by the back channel which is due to silver metal particles 234, 238 in the blue and green layers 246, 244.

The front-through signal records the radiation 230 that is transmitted through the developing film 220 from the illumination source 218 in back of the film 220. The set of front-through signals for an image is called the front-through channel (T). Likewise, the back-through signal records the radiation 240 that is transmitted through the developing film 220 from the source 216 in front of the film 220. The set of back-through signals for an image is called the back-through channel (T). Preferably, the front source 216 is energized at a first instance in time to record the front signal and back-through signal, and the back source 218 is energized at a separate instance in time to record the back signal and front-through signal. Both through channels record essentially the same image information since they both record attenuation of the radiation 230, 240 due to the silver metal particles 234, 236, 238 in all three red, green, and blue recording layers 242, 244, 246 of the film 220. Accordingly, one of the through channel signals can be disregarded.

Several image processing steps can then be used to convert the illumination source radiation information for each channel (B, F, and T) to the red, green, blue values similar to those procured by conventional scanners for each spot on the film 220. These steps are conducted because the silver metal particles 234, 236, 238 that form during the development process are not spectrally unique in each of the film layers 242, 244, 246. These image processing steps are not performed when conventional scanners are used to scan film after it has been developed, because the dyes which are formed with conventional chemical color development of film make each film layer spectrally unique. However, just as with conventional scanners, once red, green, and blue values are derived for each image, further processing of the red, green, and blue values is usually done to enhance, manipulate, display, and/or print the image.

Moreover, the exemplary digital film development system shown in FIGS. 1 and 2 can produce multiple digital image files for the same frame at different film development times, each image file having back, front, and through values which are created using the duplex scanning method described above. It can be desirable to create multiple duplex-scanned image files for the same frame at separate development times so that features of the image which appear at various development times can be recorded. During the film development process, the highlight areas of the image (i.e., areas of the film which were exposed to the greatest intensity of light) will develop before those areas of the film which were exposed to a lower intensity of light (such as areas of the film corresponding to shadows in the original scene). Thus, a longer development time will allow shadows and other areas of the film which were exposed to a low intensity of light to be more fully developed, thereby providing more detail in these areas. However, a longer development time will also reduce details and other features of the highlight areas of the image. Thus, in conventional film development, one development time must be selected and this development time is typically chosen as a compromise between highlight details, shadow details and other features of the image which are dependent on the duration of development. Scanning this developed film image using a conventional film scanner will not revive any of these details which are development-time dependent. However, in the exemplary digital film development process of FIGS. 1 and 2, such a compromise need not be made, as digital image files for the same image can be created at multiple development times while the film develops, and these multiple images can be combined to produce an enhanced image.

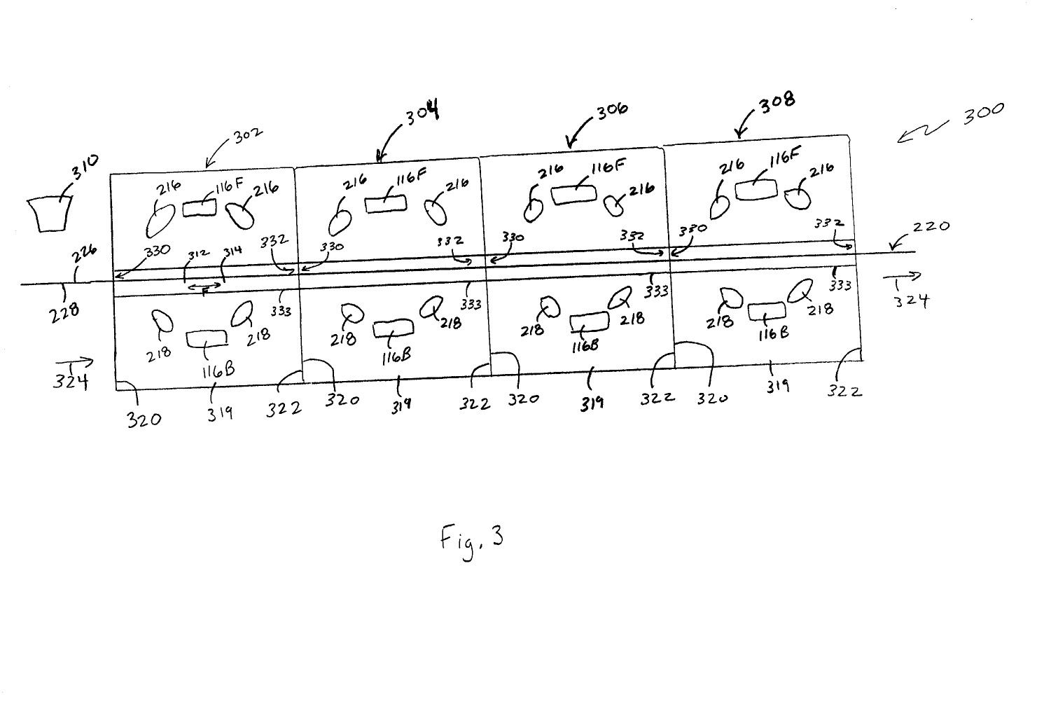

As shown in FIG. 3, multiple separable scanning modules 302, 304, 306, and 308 can be utilized to produce the multiple digital image files of the same image. Each module 302, 304, 306, and 308 in the digital film processing system 300 includes a front source 216, a back source 218, a front sensor 116F, and a back sensor 116B, which operate as described above with respect to FIGS. 1 and 2. In particular, with reference to FIGS. 2 and 3, the front sensor 116F detects reflected radiation 222 (generated by front source 216), and also transmitted radiation 230 (generated by the back source 218). Likewise, the back sensor 116B detects the reflected radiation 224 (generated by back source 218), and the transmitted radiation 240 (generated by the front source 216).

Referring now solely to FIG. 3, the modules 302, 304, 306, and 308 are serially connected to form the system 300. This system 300 has a pipeline configuration. In particular, each module 302, 304, 306, and 308 has a mounting member or panel 319, to which the various components of the module are secured. Each panel 319 has a film input side 320 and a film output side 322. In addition, each module 302, 304, 306, and 308 also has a film transport or guide assembly 333 having a film input opening 330 to receive the film, and a film output opening 332 to allow the film to exit. For example, each transport assembly 333 could define a slot within which an edge of the film is threaded. Thus, the edges of the film could be carried between two slotted rails or edge guides. The film input opening 330 of the first module 302 receives the film after developer has been applied by a suitable developer dispenser 310. The film output opening 332 of the first module 302 connects with the film input opening 330 of the second module 304, and the film output opening 332 of the second module connects with the film input opening 330 of the third module 306.

Likewise, the film output opening 332 of the third module 306 connects with the film input opening 330 of the fourth module 308. Thus, the film travels in the direction 324 from the first module 302, to the second module 304, to the third module 306, to the fourth module 308. Finally, the film 220 exits from the system 300 via the film output opening 332 of the fourth module 308.

The film 220 can be transported as a continuous strip through the film transport assemblies 333 of the modules 302, 304, 306, and 308 by suitable film transportation actuators, conveyors, and the like, exemplary embodiments of which are described in more detail below. Because of the time lag between transportation of an image on the film 220 between the modules 302, 304, 306, and 308, each module scans and records a digital image file of a given image at a different development time during the development of the film.

For example, each image or frame on the film, such as frame F which resides between the points 312 and 314, could have developer applied thereto, such as by using dispenser 310. The transportation actuator would then move the frame F through the film transport assembly 333 of the first module 302, where a first digital image file is created, using two reflectance signals (a back reflectance signal and a front reflectance signal) and one transmission signal (a back-through signal or a front-through signal) as described above with respect to the description of duplex scanning. The frame F would then be transported to module 304 where a second image file is created of the same frame, again using duplex scanning with two reflectance signals and one transmission signal. However, because of the predefined time lag in transporting the frame F from the first module 302 to the second module 304, the frame F would be scanned by the second module 304 at a later point in the development of the image in the frame F. Thus, some features of the image which might be appearing within the frame F during the development of the film 220 might be captured in the first data image file, but not in the second data image file, and vice versa.

The additional modules 306 and 308 can be connected into the system 300 to provide additional image data files for the frame F at additional development times of the frame. For example, after the second image data file is created for the frame F by the second module 304, a third image data file could be created for the frame F at a later development time by the third module 306 which would obtain two reflectance signals and one transmission signal. Similarly, a fourth image data file could be created by the fourth module 308 at the longest development time, also by obtaining two reflectance signals and one transmission signal. In this manner, four digital representations of the same frame image may be obtained at different development times, such as at 25%, 50%, 75%, and 100% of the total development time, for example. These four digital representations may then be combined with one another (i.e., stitched together) to form a composite digital representation of the image. This digital representation may be viewed on a video monitor associated with a computer, or printed on a printer connected to computer (such as a laser printer or an ink jet printer)

As shown in FIG. 3, each module 302, 304, 306, and 308 is separable from the system 300. Accordingly, although the system 300 is shown with four modules, the system can be easily provided with fewer than four or more than four modules as desired by the user. A housing (not shown) for the entire system 300 can be provided, and each module 302, 304, 306, and 308 can be moved into and out of the system housing as desired by installing the mounting panel 319 for the module into the housing, or removing the mounting panel 319 from the housing. Because the various components (e.g., 216, 218, 116F, 116B, 333) of each module are secured, directly or indirectly, to the mounting panel 319, the entire module can be handled by manipulating the panel 319. As an alternative to the mounting panel 319, other mounting members or housings could be utilized to secure the various components of a single module for ease of handling. If such a scanning system is utilized, all modules can have substantially identical components and a substantially identical configuration of such components, such that the replacement of the broken module does not hinder the operation of the system.

Accordingly, because of the removability and standard design of the modules 302, 304, 306, and 308, the system 300 remains flexible, and easy to upgrade and service.

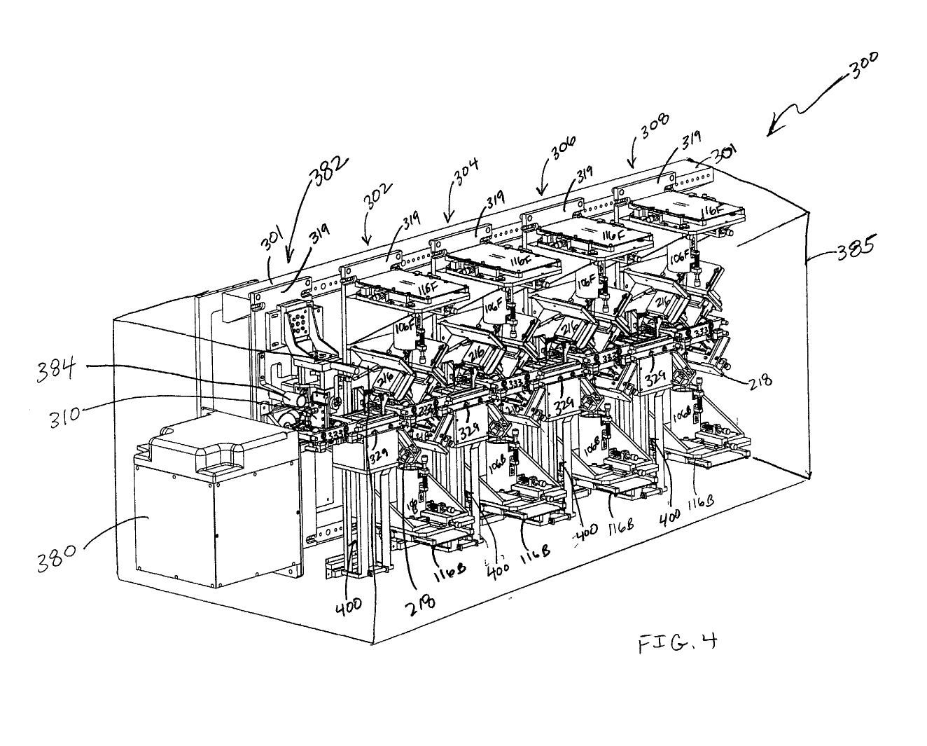

FIGS. 4 and 5 illustrate a more detailed exemplary embodiment of the modular digital film development system of FIG. 3. In this embodiment, in addition to the radiation sources 216 and 218, the sensor circuit boards 116F and 116B, the mounting panels 319, and the film transport/guidance assemblies 333, each of the four modules 302, 304, 306, and 308 also include a pair of optics units 106B and 106F. As discussed above, the optics units 106B and 106F are used to focus the radiation from the sources 216 and 218 onto the respective sensors 116B and 116F.

As also shown in FIGS. 4 and 5, a film loading unit 380 can be provided to input the film into the system 300, and to cut the film and/or a leader strip if desired. Film loading and cutting actuators can be provided to assist in the cutting and loading of the film. These actuators can include motors, solenoids, and other appropriate devices. Also shown in FIG. 4 is a slot coater module 382 which includes a slot coater head 310 to apply developer to the film and a slot coater wiping roll 384 to clean the film prior to the developer application. The components of the slot coater module 382 are also secured to a panel 319 for ease of removal and handling. Like the scanning modules 302, 304, 306, and 308, the slot coater module 382 also includes a film transport assembly 333 for transporting the film.

In the exemplary system 300 shown in FIGS. 4 and 5, the modules 382, 302, 304, 306, and 308 are secured within the system 300 by connecting the mounting panel 319 to a frame 301, which preferably has apertures to receive pins or other connection mechanisms for securing the mounting panel to the frame. Preferably, the entire system 300 resides within a housing or cabinet 385 which provides a dark environment for the film development, and which also allows the system to be contained and moved as a unit, if desired.

In addition, as also shown in FIGS. 4 and 5, film buffer assemblies 329 can be located between the film transport assemblies 323 of each module 382, 302, 304, 306, and 308, to compensate for tension and/or slack in the film between the modules, and to allow the film to develop further between the modules. As shown in FIGS. 4 and 5, these buffer assemblies 329 can act as additional film guides or tracks which are in line with the film transport assemblies 333 of the modules 302, 304, 306, and 308, and are placed in between the tracks of the assemblies 333. These buffer assemblies 329 can include a hinged trap door or platform over which the film can move.

When the door is in the closed position, the film can be threaded through all sections of the transport assembly 333. However, the doors in the buffer assemblies 329 can be selectively moved from a closed position to an open position to allow the film to spill downwardly toward the bottom of the given module 382, 302, 304, 306, or 308. Accordingly, if the film driving actuators of the various modules 382, 302, 304, 306, and 308 have slight differences in speed or movement of the film 220, rather than resulting in jamming or buckling of the film in the tracks assemblies, the film 220 can move downwardly through the opening where the trap door once was located and into the film spill channel 400, which is defined by a pair of parallel film guide members or strips 400L and 400R. Thus, the system 300 will avoid malfunction and the film development process conducted can continue without interruption, thereby reducing maintenance downtime and related expense.

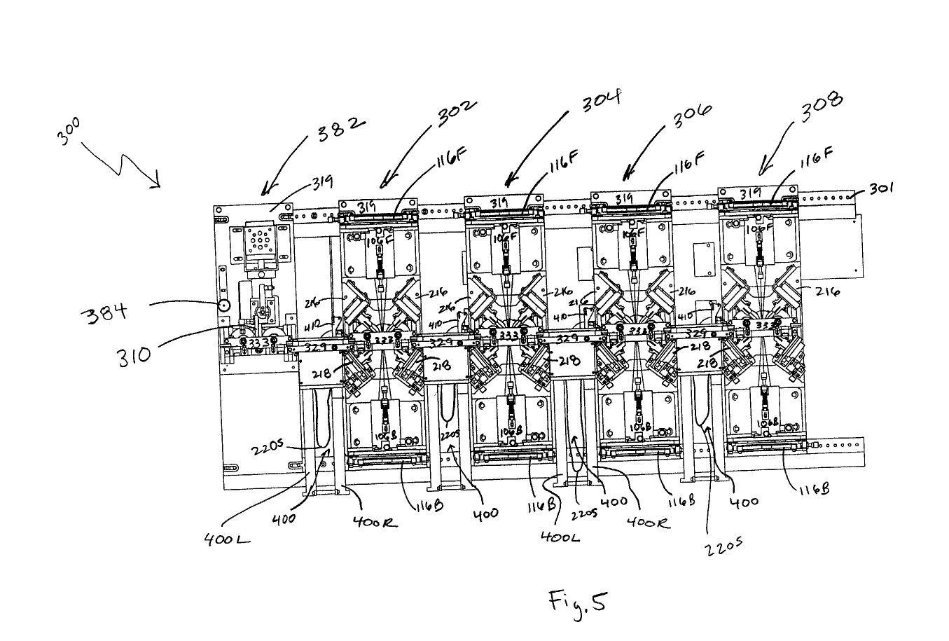

FIGS. 6 and 7 show two exemplary embodiments of film guidance/transport assemblies 333 which can be used in any of the modules 382, 302, 304, 306, and 308 of the modular film development systems of FIGS. 3, 4 and 5. Such assemblies 333 can be used in other film scanning systems as well, such as those which use only one scanning module and apply radiation from one side of the film. Included in each assembly 333 is an upper transport housing 340 which secures to a lower film guide 327. The developing film is transported and guided between the transport housing 340 and the lower film guide 327, such as by moving the film through a slot formed between the housing 340 and lower film guide 327.

According to principles of the present invention, the lower film guide 327 includes an arcuate film scanning bridge 325 (i.e., film support) with a center scanning opening or slot 370. The film travels over the bridge 325 but beneath the transport housing 340 during scanning. Radiation is directed through the slot 370 to sequentially scan rows of the developing film. The bridge 325 can be in the shape of an arc which is circular in nature and which has a radius of from about 1.00 to about 2.00 inches, although other dimensions are possible. However, it is contemplated that other arcuate shapes having constant or variable radius could be utilized. The film bridge 325 can be a radiused, stainless steel metal part, which is mounted by screws or connectors. Because the film is flexible, as photographic film typically is, it takes on a raised shape as it moves over the arcuate scanning bridge 325. By positioning the film in a curved or arcuate or raised shape, it is possible to accurately control the location of the top surface of the film, which can be important in digital film development to provide good scanning results, as the scanning equipment (e.g., a source and/or a sensor) is precisely focused to a particular depth where the film is expected to reside. Tensioning the film over an arcuate or curved or raised surface allows little possibility that the film will wrinkle, bend, or buckle or take on uncontrolled shapes which may affect the radiation which is sensed by the sensor, and thereby cause inaccurate digital image data. In particular, tensioning the film over an arcuate surface reduces the risk that the film will rise off that surface, or otherwise take on an uncontrolled shaped, and consequently focus the scanning equipment off of the image on the film. In contrast, positioning the film on a flat surface is less preferred, as the film may more easily rise off of such a surface. The purpose of the slot 370 is to allow radiation to pass through the film.

The film transport assemblies 333 can include driving mechanisms and linkages to force the film over the arcuate bridge 325. More specifically, a motor 350, or other suitable drive mechanism or actuator, can be provided to supply the driving force for moving the film between the transport housing 340 and the lower film guide 327. The motor 350 can comprise any suitable motor for supplying the driving force, such as an AC or a DC motor for example. Preferably, the motor 350 comprises a stepping motor, which is sometimes referred to a stepper motor. Such a motor converts electrical pulses into discrete mechanical movements of a shaft or spindle. The speed that the shaft rotates is directly related to the frequency of the input pulses, and the length of the rotation is directly related to the number of input pulses applied. One advantage of using a stepper motor is its ability to be accurately controlled without the need for closed loop control and the expensive sensing and feedback devices associated therewith. Because each applied pulse causes a known incremental step in rotation, the position of the motor can be known simply by keeping track of the number of input step pulses applied to the motor. A cable 351 can be provided to supply the electrical control signals to the motor 350. Such control signals can be controlled by a programmed microprocessor or controller which can be utilized to control the film movement through the assembly 333, the scanning of the film by the sources, and the creation of pixel data by the sensors. For example, the computer 120 of FIG. 1 could be utilized for controlling these operations, and for controlling the application of control signals through the cable 351 to the motor 350.

To transmit the rotational motion of the motor 350 to the film driving wheels 360, any suitable connection or linkage members can be provided. In the exemplary embodiments of FIGS. 6 and 7, the motor 350 drives a shaft 352 which has a linking gear 354 connected thereto. The linking gear 354 engages a pair of gears 358 and 356, which are connected to shafts 362 and 364 respectively. Connected to each of the shafts 362 and 364 are a pair of film driving wheels 360. Spacers 361 and other suitable connection members can be utilized for placement of the wheels 360 along the shafts 362 and 364. The wheels 360 could comprise friction wheels or pinch rollers, in which case the bottom 366 of each wheel 360 contacts the top surface of the film near the edge of the film and clamps the film between the wheel 360 and a surface 368 to thereby force the film between the lower film guide 327 and the transport housing 340 of the film guide assemblies 333 of FIGS. 6 and 7. In the embodiment of FIG. 6, the surface 368 resides on four rollers 367. These rollers 367 may be splayed toward the side edges 369 of the lower film guide 327. By splaying the rollers 367, the film can be tensioned in the film's transverse direction 381 during scanning to thereby further resist the wrinkling or other uncontrolled movement of the film and provide optimum scanning results.

As is also shown in the exemplary embodiments of FIGS. 6 and 7, the film can be placed in tension in the longitudinal direction 383 as it is scanned by the sources. In particular, the gears 356 and 358 are sized such that the shaft 362 rotates slightly slower than the shaft 364. For example, the speeds of the shafts 362 and 364 can differ by at least 1.5 percent, such as by between about 5 and about 12 percent, although other variations are possible. This causes tension across the film between the shaft 362 and the shaft 364, as the film row over the opening 370 is being scanned. As noted above, tensioning the film can ensure that the film remains flat during the scanning process. Buckling or wrinkling of the film during scanning can result in inaccurate image data. The tension provided on the film can be from about 0.5 ounces to about 10 pounds, from about 4 ounces to about 14 ounces, or from about 8 to about 12 ounces, although any tension which does not tear the film can be utilized. The differing speeds can be accomplished by providing gears 356 and 358 with differing numbers of teeth. For example, gear 356 could have 168 teeth, while gear 358 could have 180 teeth, providing a gear ratio of 168 to 180, although other ratios are possible.

To prevent the film from tearing due to the difference in speeds of the rotating shafts 362 and 364, a slip clutch 371 or other friction device can be used to disengage the gear 358 from the link gear 354. In particular, the slip clutch 371 will disengage the gear 358 from the link gear 354 when the torque on the shaft 362 reaches a predetermined level due to the film being pulled by the shaft 364. The slip clutch 371 can comprise any suitable slip mechanism that disengages a gear and/or reduces torque upon application of a predefined overload torque level. Suitable slip clutches may include spring members, friction devices, sliding plates, and/or ball elements, for example. Thus, the slip clutch 371 can cause the shaft 362 to slip relative to the shaft 352 when subjected to an overload torque. The amount of overload torque which will cause the clutch 371 to slip will be a function of the film tension and the drive wheel diameter. As an alternative to a slip clutch 371 and driving gears 356 and 358, other mechanisms for maintaining tension on the film without tearing the film could be utilized.

In addition to the center opening 370, a reference area 390 can be provided. Medium delivered through this area 390 can be scanned to provide a reference or target against which the images scanned from the scanning row 370 can be corrected, calibrated, normalized, or otherwise processed.

While FIGS. 6 and 7 illustrate exemplary film transport/guidance systems and components, other systems and components can be used to drive and transport the film. For example, the film can be driven by a single shaft rather than a pair of shafts, and tension can be provided, if desired, by a resistance to the forward film movement. Moreover, the wheels 360 could comprises sprockets which engage openings on the film edges. As another alternative, rather than engaging the film directly, the wheels 360 could engage a conveyor tape or belt which in turn is connected to or supports the film. Furthermore, a roller or capstan can be used to drive the film. Other suitable linkages may also be utilized, such as belts for example, in transmitting the power from the driving mechanism to the film. Moreover, in addition to the transportation elements disclosed in FIGS. 6 and 7, other rollers, wheels, spindles, spools, and related devices can be utilized in the systems of FIGS. 3, 4, and 5 to complete the transportation of the film through the system.

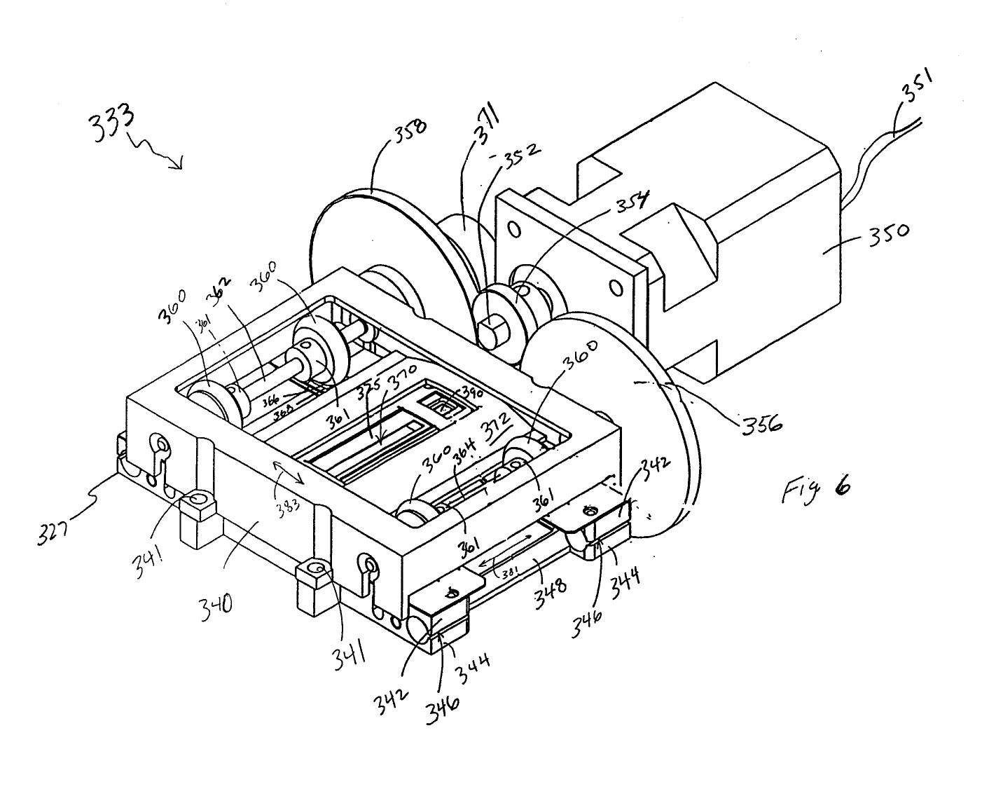

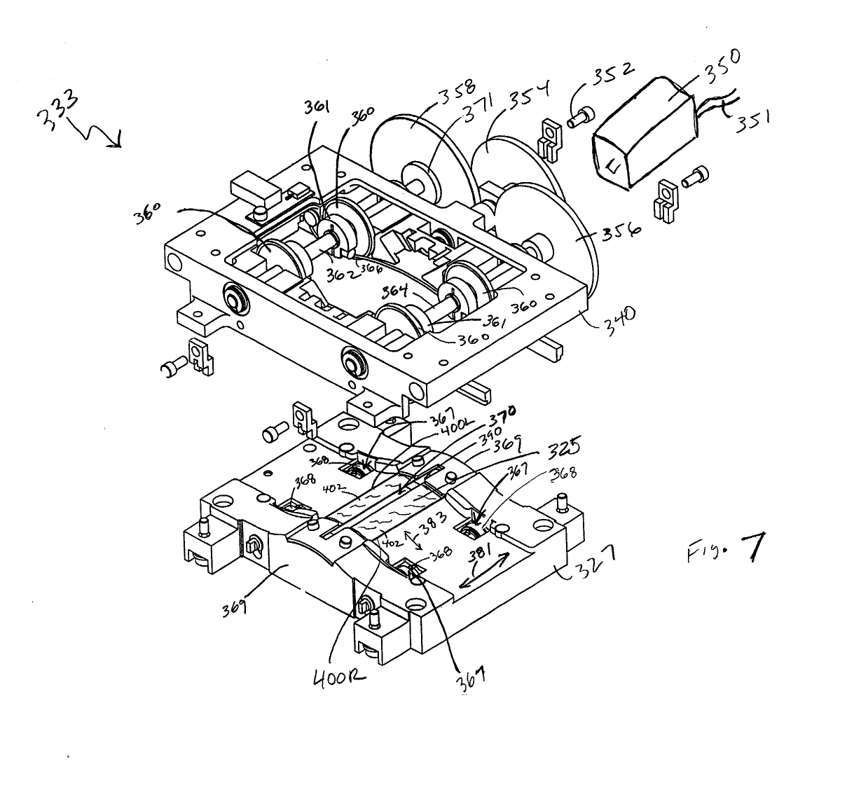

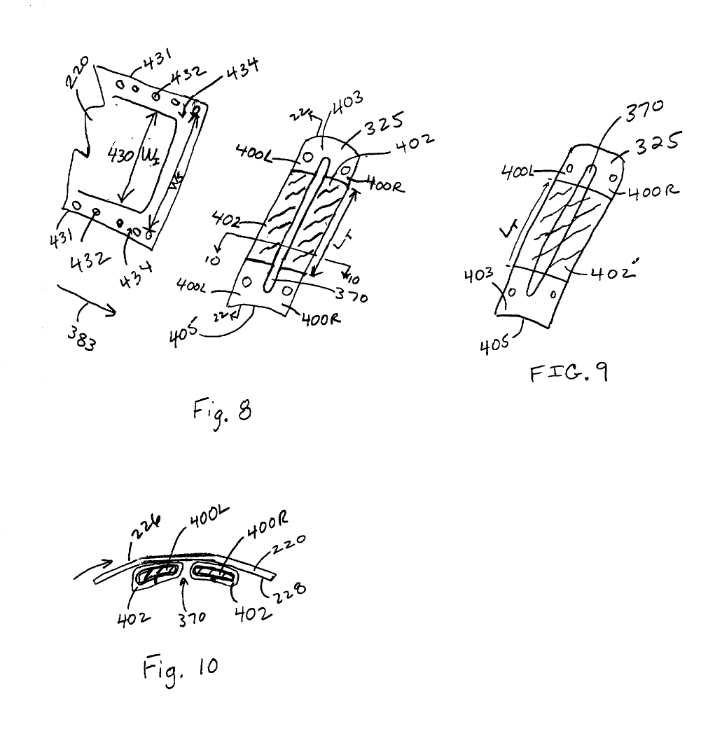

In one exemplary embodiment, and as best shown in FIGS. 7 and 8, the arcuate (e.g., radiused) film bridge 325 can include material 402 applied to the left member 400L and right member 400R of the film bridge. These members 400L and 400R (e.g. elongated strips) define the slot 370 through which the scanning radiation is passed and applied to the film. The material 402 may be applied to the film facing side 403 of the bridge 325, although the material could cover both sides 403 and 405 of these members. Other options are also possible. For example, as shown in FIG. 9, a single tape portion 402′ may be applied to one or both sides 403 and 405 of the film bridge 325. In this embodiment, the left and right members 400L and 400R are covered by a single tape portion 402′, which also covers the slot 370. This tape portion 402′ should be transparent to the radiation applied so as to avoid any interference with the scanning process.

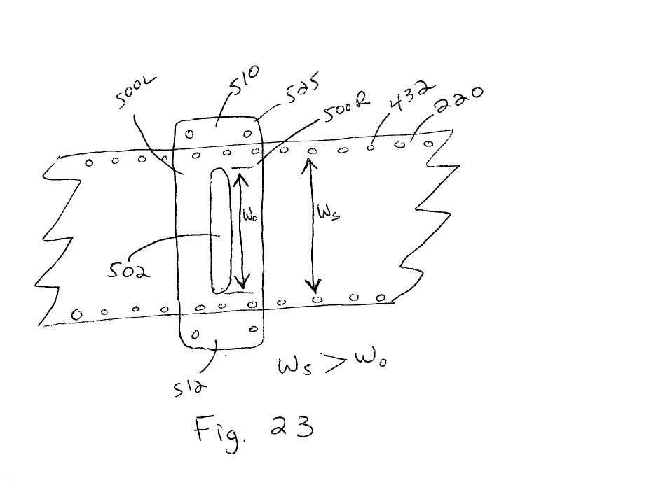

FIG. 10 is a cross-sectional view of the film bridge 325 of FIG. 8, taken along line 10-10 of FIG. 8. As shown in this figure, in this exemplary embodiment, the film 220 slides over the material 402 as it is transported over the bridge 325, rather than contacting the members 400L and 400R directly. By utilizing the material 402, it has been found that better motion quality of the film 220 results. In particular, it has been found that film may shake, bounce, or vibrate when its edges contact the film bridge near the sprocket holes. This vibration may be due to the sprocket holes which are placed in 35 mm film. Sprocket holes are created by punching holes into the film which creates localized deformations and residual stresses around the holes. Such deformations and stresses alter the stiffness of the film creating non-uniform characteristics along the length of the film. The resulting vibration may bring the film in and out of focus during imaging, resulting in poor image data quality. However, it has been found that raising the film 220 by using the material 402 minimizes such vibration and provides better motion quality and, accordingly, image data quality. In particular, the material 402 can be applied to the bridge 325 in an area which would not contact the sprocket holes 432 of the film 220, as best shown in FIGS. 8 and 22 (which is a cross-sectional view of the embodiment of FIG. 8, taken along line 22-22). In other words, when film 220 is moved over the bridge 325 in the longitudinal (i.e., film travel) direction 383, the sprocket holes 432 and the edge portions 435 of the film are raised off of the bridge 325. In such an embodiment, the sprocket holes 432 and edge portions 435 do not contact the material 402 or the bridge 325, but rather are suspended by the support of the material 402 in the central image portion 430 of the film 220. This can be accomplished by making the length (L_{T}) of the material 402 less than the width (W_{S}) of the film 220 between the sprocket holes 432 along the transverse side edges 431 of the film, as shown in FIGS. 8 and 22. In addition, the length (L_{B}) of the bridge 325 can be greater than both the length (L_{T}) of the material 402 and the width (W_{S}) of the film 220 between the sprocket holes 432, as best shown in FIG. 22. For instance, the length (L_{T}) of the material 402 can be equal to or less than the width (W_{I}) of the image area 430 (i.e., the area of the film 220 where the images are recorded) (For C-135 type film, the width W_{I} is approximately 24 mm). According, the film 220 is supported on the material 402 only in the central area 430 where images are formed on the film, and the edges 434 of the film are suspended and do not contact any structure. By avoiding sliding contact with the areas 434 near the is sprocket holes 432, the movement variations which are caused by the mechanical deformations of the film 220 in these areas can be minimized.

In one embodiment of the film bridge design of FIGS. 8, 10, and 22 having material applied thereto, the film is transported over the bridge 325 with 4 to 5 microns peak to peak of dynamic vertical variation (dvv) at the image plane (the apex of the bridge 325), as measured by a laser sensitometer, with a film transportation velocity of 10 mm/s. In other words, each vertical motion (i.e, change of position) of the film in one direction during transportation at 10 mm/s is less than or equal to 5 microns. One exemplary film bridge 325 can provide less than or equal to 7 microns peak-to-peak of dynamic vertical variation of the film during imaging (with the film moving at 10 mm/s), such as less than or equal to 5 microns peak-to-peak. In such an embodiment the static vertical variation (svv) (i.e, total difference between the highest and lowest positions recorded during the test) is less than or equal to about 13 microns, such as less than or equal to about 8 microns. FIG. 11 is an exemplary graph illustrating the dynamic vertical motion which is achieved with one embodiment of the film bridge design, although other variations are possible.

In addition to raising the film edges from contacting other surfaces, the material can also reduce scratches that are imparted to the film 220, which can reduce image quality. In other words, the material 402 can provide a smoother edge when applied to the bridge 325, and can thereby reduce the scratching of the film which can occur by using the bridge alone. In one exemplary embodiment, the material comprises a TEFLON (polytetrafluoroethylene) impregnated tape. Other potential materials include TEFLON impregnated anodize, laboratory grown diamond materials, nickel materials, and other friction reducing coatings and materials. Other possible materials can include low friction materials (i.e., having low coefficients of friction), or other smooth or scratch-resistant material applied to the bridge members 400R and 400L. If tape is used, the tape 402 may have one adhesive surface to allow it to easily adhere and secure to the members 400L and 400R. Alternatively, an adhesive substance or a fastener could be used to apply the tape 402 to the bridge 325. As an alternative to tape 402, a coating or film or other material or substance may be applied (e.g. sprayed or coated or molded) to the members 400L and 400R, or the members and/or bridge 325 may be made of a suitable material and of a desired shape to provide the desired transportation during scanning. As can be understood, during scanning, the back 228 of the film 220 may be irradiated and imaged through the slot 370, as shown in FIG. 10. The front 226 of the film may be imaged as well, as described above.

More specifically, operation of the exemplary film development system will now be described with reference now to FIGS. 4-10, and 22. Once the film has reached a location in the first scanning module 302, a trap door in the film buffer assembly 329 between the slot coater module 382 and the scanning module 302 opens via a control signal from the controller. (The position of the film can be sensed by any suitable sensor, such as an infrared sensor.) Then, the motor 350 in the slot coater module 382 could be activated to continue to drive the film, while the motor 350 in the first scanning module 302 could be stopped. Accordingly, the film will spill downwardly into the film spill channel 400 between the modules 382 and 302. Once a predetermined amount of film has been spilled out, or the motor of module 382 has been driven for a period of time, the motor 350 of scanning module 302 can once again become active and the film can be driven further toward the second scanning module 304. A similar film spill process can then occur when the film reaches a predetermined position in the second scanning module 304, the third scanning module 306, and the fourth scanning module 308. Accordingly, slack zones 220S will exist in the film between the various modules 382, 302, 304, 306, and 308, as shown in FIG. 5. These zones 220S alleviate film buckling or jamming which may occur due to differences in the film driving speeds of the various modules. Moreover, these slack zones give the film 220 additional time to develop between modules, without requiring an increase in size of the system 300 or a decrease in speed of the digital film development process. The amount of additional development time can be adjusted by changing the length of film that is allowed to spill in to the slack zone.

As noted above, the portion of the film being scanned can be tensioned in both the longitudinal and transverse directions as it travels over the bridge 325. The material 402 over the bridge 325 provides a smooth, low friction, scratch-resistant surface over which the film 220 can travel as it is imaged. During imaging, radiation can be applied to the film at the slot 370 using the sources 216 and 218. For each pixel, reflected radiation can be sensed from the back and front of the film using sensors 116F and 116B. Radiation transmitted through the film can also be sensed. (Sources 216 and 218 can be fired at separate times to allow the sensors 116F and 116B to distinguish between reflected and transmitted radiation.) Accordingly, back, front, and/or through data can be obtained for each pixel of the image, and this data can be used to derive R, G, and B signals for the image. For each image, multiple sets of back, front, and through data can be obtained at differing film development times using the various scanning modules 302, 304, 306, and 308. These multiple data sets for each image can be combined to form an enhanced image which includes features from various film development times. Other embodiments are also possible for use with bridge 325, such as those described above which apply radiation to only one side of the developing film using one sensor and a single scanner module at a single development time.

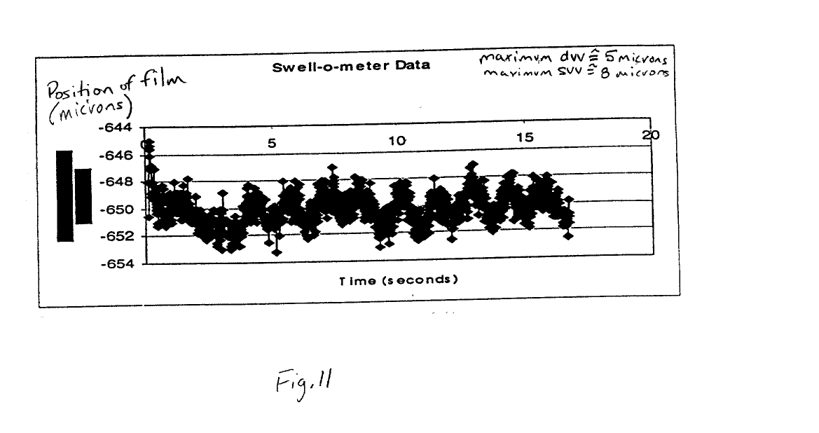

FIGS. 12a and 12b illustrate an alternative film bridge 421 which can be substituted for the film bridge 325 of FIGS. 8-10 and 22. In this embodiment, the film bridge 421 comprises a mounting assembly 426, and the bridge members comprise a pair of parallel transverse rollers 420 secured to the assembly 426. The rollers 420 may be attached to the assembly 426 in any suitable manner. For instance, in the exemplary embodiments of FIGS. 12a and 12b, the rollers rotate about a pair of fixed shafts 422 which are secured to the assembly 426 using fasteners 424, such as nuts, bolts, screws or the like. In the embodiment of FIG. 12a, the shafts 422 are secured to raised side walls 425 on the assembly 426, while in the embodiment of FIG. 12b, the shafts 422 are secured to raised mounting blocks 427 on the assembly. In one embodiment, the rollers 420 have a diameter of between about 0.1250 inches and about 0.3750 inches, such as a diameter of around 0.1875 inches, although other diameters are possible.

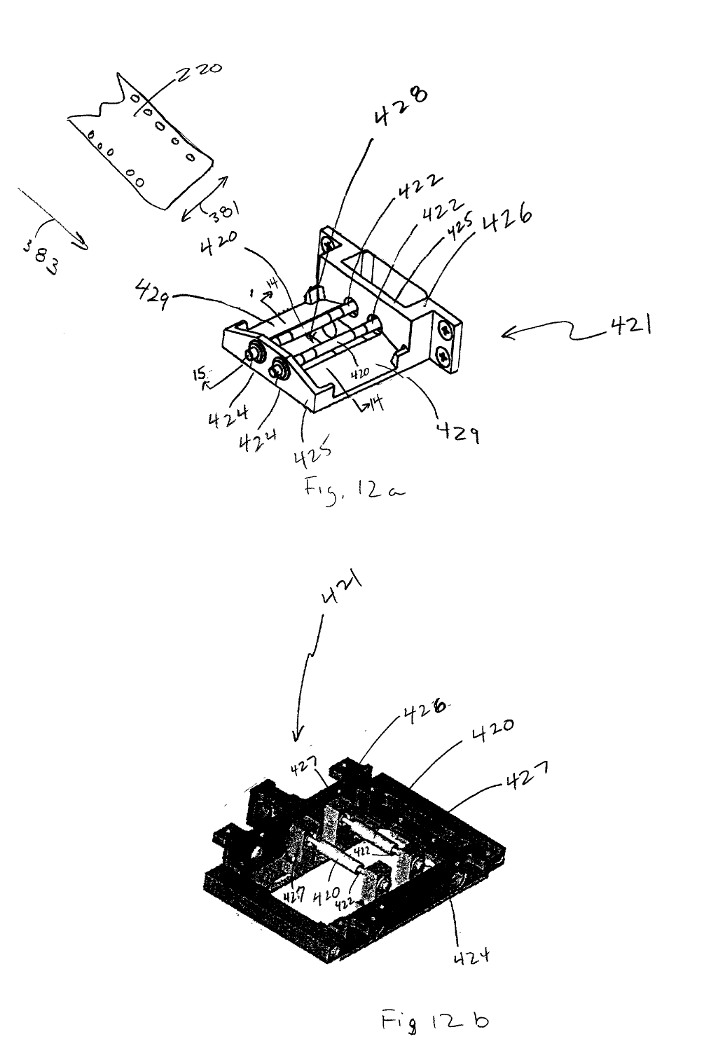

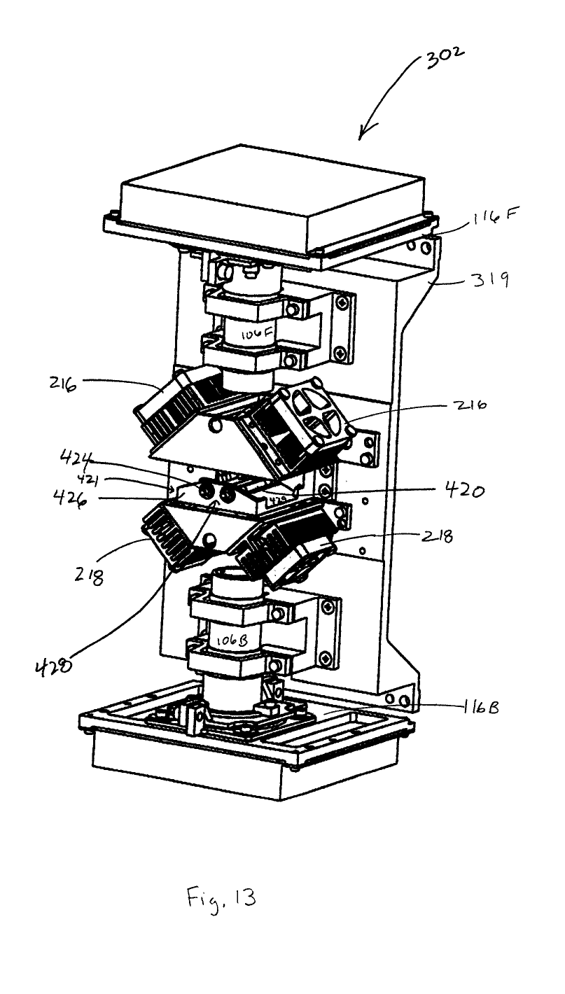

Accordingly, as seen in FIG. 13, the mounting assembly 426 may be secured to the mounting panel 319, such as by using bolts, fasteners, or the like. The rollers 420 are positioned before and after the imaging area 428, which is the area where radiation is applied by one or more sources and sensed by one or more sensors. As shown in FIGS. 12a and 12b, the rollers 420 are spaced in the longitudinal direction 383 (i.e., the film travel direction) so that each roller spans the film in a transverse direction 381 across the width of the film 220 at spaced locations along the longitudinal length of the film. In this embodiment, the rollers 420 are spaced between about 0.500 inches and about 1.215 inches apart (center to center), Such as about 0.655 inches apart, although other spacings are possible. However, it has been found that spacing the rollers 420 an integer multiple of the longitudinal distance between (i.e., frequency of) the sprocket holes along a film side edge can result in excessive vertical movement of the film during transportation. In contrast, spacing the rollers 420 a non-integer multiple (e.g. i.1, i.2, i.3 etc.) of the sprocket hole frequency can reduce the vertical vibration of the film and thus provide better imaging results.

This spacing relationship is shown in FIG. 14, which is a cross-sectional view of the embodiment of FIG. 12a. The distance between the sprocket holes 432 on the film 220 is shown as the variable d and the spacing of the rollers 420 is shown as the variable s. In this example, the spacing s is not an integer multiple of the distance d. For instance, the spacing s can be a half integer multiple of the distance d such that:

s=(i.5)(d)

where the variable i is a positive integer. As an example, if the sprocket hole frequency d were 3/16 of an inch (0.1875 inches), the spacing s could be chosen to be 1.5 times d (or 0.28125 inches), 2.5 times d (or 0.46875 inches), 3.5 times d (or 0.656 inches), etc.

The film 220 may be transported over the rollers 420, such as by using a motor or in any other suitable manner, such as by using the methods and apparatus described above. The rollers 420 can rotate during movement of the film, to prevent scratching of the film which can occur with sliding or scraping contact with the film. The two rollers 420 support the film for stability during imaging, as shown in FIG. 14. In this embodiment, the film 220 moves over film transport ramps 429, which are a part of the assembly 426, and contact the rollers 420, which rotate during movement of the film, to reduce scratching of the film. In this example, the tension applied to the film during transportation is between about 200 grams (1.96133 Newtons) and about 1000 grams (9.80665 Newtons), such as about 500 grams (4.90333 Newtons), although other tensions are possible.

Returning again to FIG. 13, during the movement of the film over the rollers 420, radiation may be applied by the sources 216 and 218 and sensed by the sensors 116F and 116B, such as in the manner described above. Multiple images may be taken, as also described above, to create multiple digital images which may be combined to form a single digital image.

FIG. 15 is a cross-sectional view of the bridge assembly 421 of FIG. 12a, taken along one of the rollers 420. As shown in this exemplary embodiment, the diameter of the roller 420 is larger than the diameter of the shaft 422 which is arranged concentrically with the roller 420. In addition, the length Lᵣ of the roller is less than the width W_{S} of the film between the sprocket holes. In this manner, the film 220 makes contact with the roller 420 only in the central portion 430 of the film where the latent image is present. Accordingly, the side portions 434 of the film 220, where the sprocket holes 432 may be found, do not make contact with the roller 420, and can suspend from the edges of the roller. Because the side portions 434 may be mechanically distorted by the formation of the sprocket holes 432, these portions 434 can contribute to vibration and bounce during transportation of the film 220. Accordingly, avoiding contact of the roller 420 with these portions 434 can reduce vibration of the film 220. For example, the length Lᵣ of the rollers 420 can be less than or equal to the width W_{I} of the central image portion 430 of the film 220.

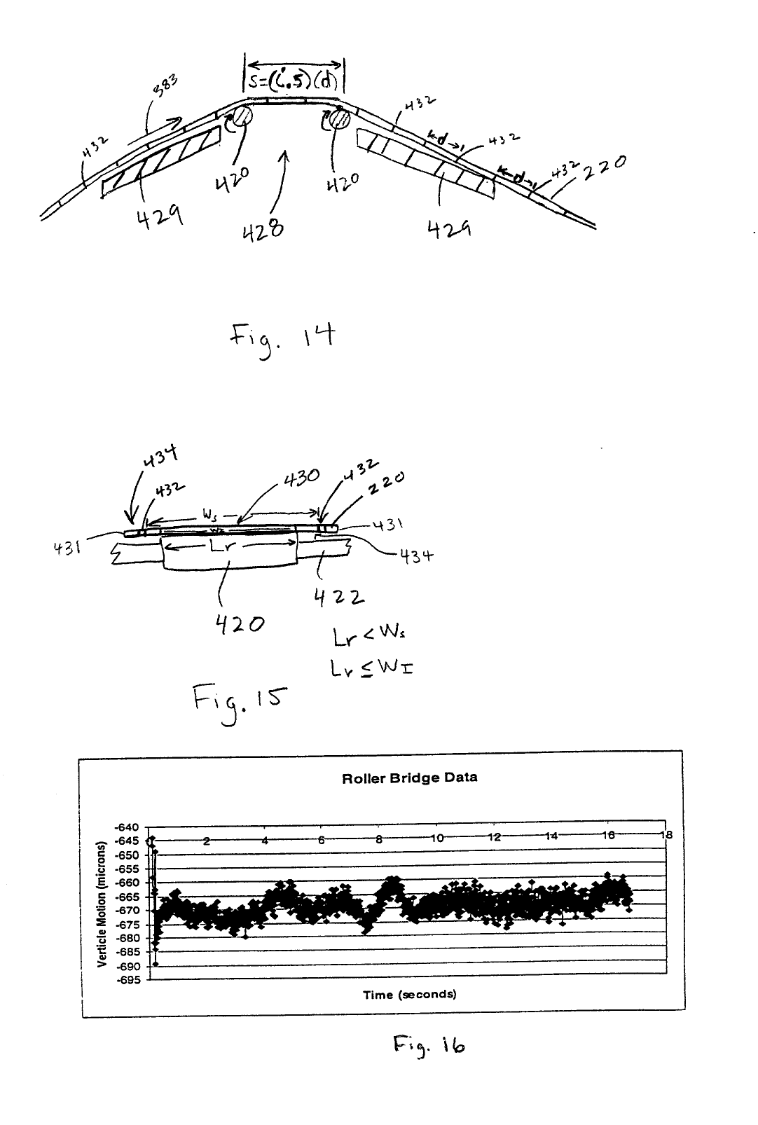

FIG. 16 is an exemplary graph showing vertical vibration data for a dual roller bridge design such as shown in FIGS. 12-15, having roller diameter of 0.1875 inches, roller spacing s of 0.655 inches, a film speed of 10 mm/s, and a film tension of 500 grams. As shown in this graph, the dynamic vertical movement of the film for this film bridge embodiment is less than or equal to about 8 microns peak to peak. Other dimensions and performance characteristics are also possible however.

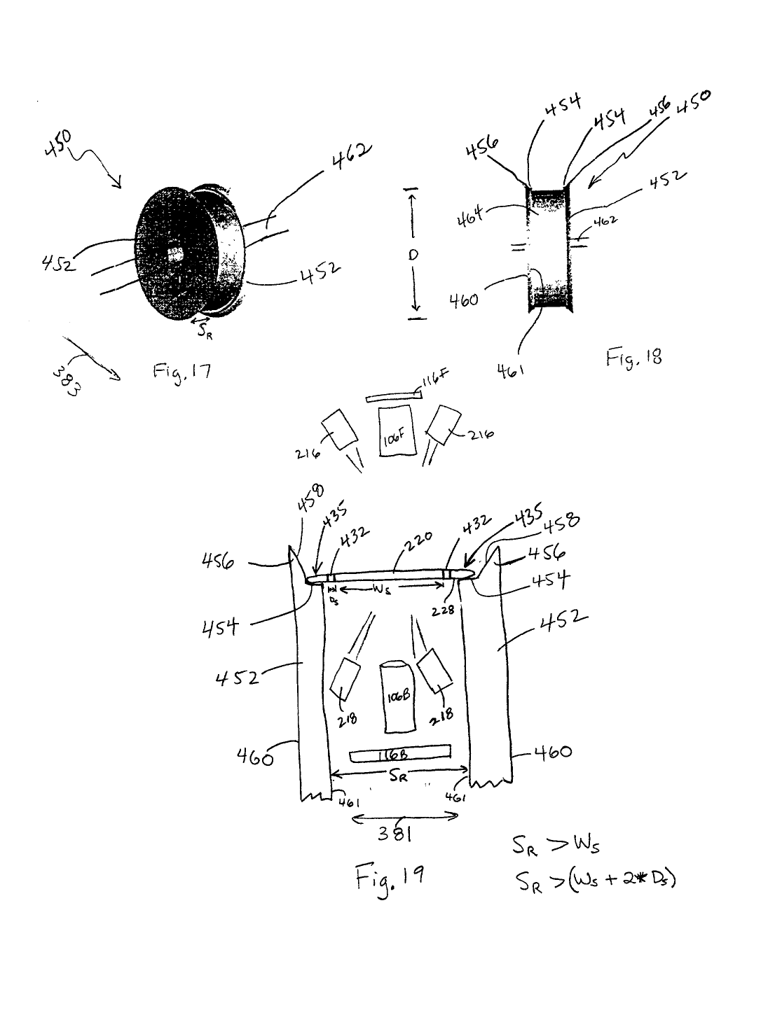

FIGS. 17-19 illustrate an embodiment of a film bridge 450 which could be utilized as an alternative to the bridges 421 and 325 described above. FIG. 17 is a perspective view, FIG. 18 is a front view, and FIG. 19 is a cross-sectional view of this embodiment (FIG. 19 shows the placement of the film on the bridge). In this embodiment, the film 220 rides on a pair of bridge members which comprise parallel, transversely spaced side rollers 452. In operation, these rollers 452 are spaced across the width of the film 220 in a transverse direction 381, which is orthogonal to the film travel (or longitudinal) direction 383. In particular, as best shown in FIG. 19, in this embodiment, the edge portions 435 of the film 220, which are outside the sprocket holes 432, ride on recessed ledges 454 which are formed in the rollers 452. For C-135 type of film, for example, each edge portion 435 is about 2 mm in width. To accomplish this, the spacing S_{R} between the rollers 452 can be made larger than the width W_{S} between the sprocket holes 432 along the two edge portions of the film 220. For example, the spacing S_{R} can be greater than the width W_{S} plus twice the sprocket hole length D_{S} (i.e., D_{S} being the dimension of the sprocket hole which is orthogonal to the film travel direction). Accordingly, it can be ensured that the roller ledges 454 will contact and support the edge portions 435 of the film 220, and the sprocket holes 432 can suspend from the ledges 454. As with some of the other embodiments described herein, by keeping any structure from contacting the areas near the sprocket holes 432, the movement variations which are caused by the mechanical deformations of the film 220 in these areas can be minimized.

Each roller 452 has a guide wall 456 around its circumference which includes an inner sloped portion 458 which slants inwardly and meets the recessed ledge 454. Accordingly, the film 220 rests on the ledges 454 of the rollers 452, but is restrained from lateral movement by sloped portions 458 of the guide walls 456 which rise above the ledges. In other words, the diameter D of the roller 452 is larger near the outer side 460 of the roller (in order to form the guide walls 456) and is smaller near the inner side 461 of the roller (in order to form the recessed ledge 454).

The side roller bridge 450 may be used to support the film 220 for scanning in one or more of the scanning modules described above. The mechanisms described above for transporting the film can be used to move the film over the roller bridge 450. In addition, the mechanisms described above can be utilized for scanning the film as it passes over the roller bridge 450. If it is desired to scan the back side of the film, and as shown in FIG. 19, the scanning mechanisms can be located between the rollers 452. In particular, radiation sources 218 can be mounted between the rollers 452 to apply radiation to the back 228 of the film 220, and/or optics 106B and sensor 116B can be used to sense radiation from the back 228 of the film. Likewise, sources 216, optics 106F, and/or sensor 116F can be located on the opposite side of the film 226. While these scanning mechanisms can be mounted in fixed manner as described above, the rollers 452 may be rotatably mounted, such as by mounting them on a shaft 462, in any suitable manner. The rollers 452 may be mounted on the shaft 462 separately with an opening or gap therebetween, or the rollers 452 may form an integral drum by connecting roller portion 464. As the edges 435 of film 220 move over the rollers 452 using transport mechanisms, the rollers rotate while the scanning mechanisms record the front, back, and/or through data from the film, such as described above.

FIG. 20 illustrates an alternative embodiment of a roller bridge 470. In this exemplary embodiment, the bridge 470 includes two spaced parallel rollers 472. The film 220 is transported over these rollers 472 and is scanned as it passes over the rollers. In this embodiment, each side portion 434 of the film 220 rides on a roller 472. Radiation may be applied to the back 228 of the film 220 from between the rollers 472 during scanning, and/or radiation may be applied to the front 226 of the film from above the rollers.

In the embodiments of FIGS. 17-20, because the rollers 452/472 rotate as the film 220 moves over them, the film 220 does not slide over or scrape against a surface, thereby reducing scratching of the film which can interfere with scanning data.

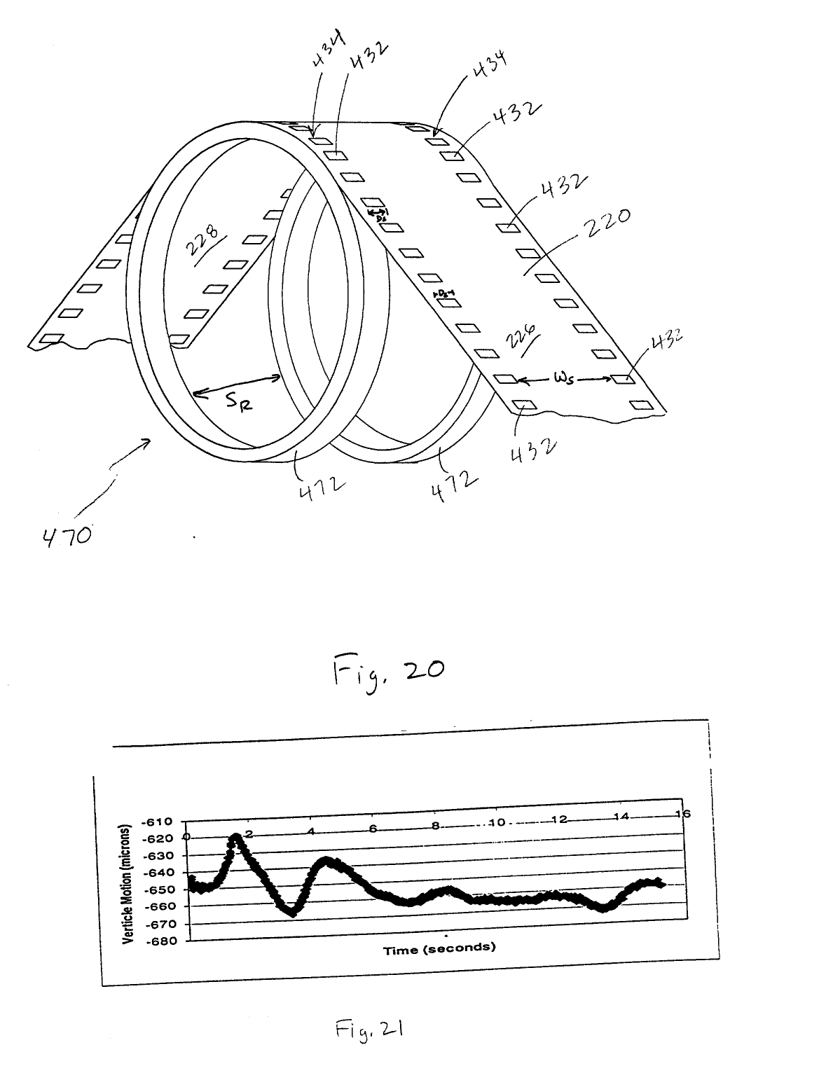

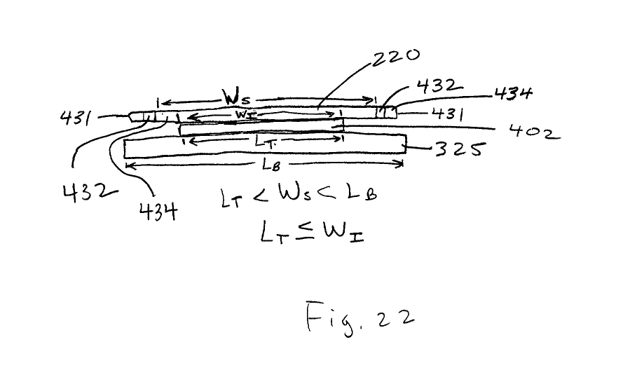

The diameter of the rollers may be varied as desired. As an example, diameters of between about 1 inch and about 4 inches could be utilized. FIG. 21 illustrates exemplary dynamic vertical motion that can be achieved using the bridge of FIGS. 17-19. In this example, the maximum dynamic vertical motion is less than about 7 microns, such as less than about 5 microns, although other results are possible.

The foregoing descriptions of the exemplary embodiments of the invention have been presented for purposes of illustration and description only. They are not intended to be exhaustive or to limit the invention to the precise forms disclosed, and modifications and variations are possible and contemplated in light of the above teachings. While a number of exemplary and alternate embodiments, methods, systems, configurations, and potential applications have been described, it should be understood that many variations and alternatives could be utilized without departing from the scope of the invention. Moreover, although a variety of potential configurations and components have been described, it should be understood that a number of other configurations and components could be utilized without departing from the scope of the invention.

For example, an alternative film bridge 525 is illustrated in FIG. 23. In this exemplary embodiment, no additional material need be applied to the bridge 525. The bridge includes left and right members 500L and 500R connected (integrally or nonintegrally) by end portions 510 and 512 so as to form a slot or opening 502. The length W_{O} of the elongated opening 502 is less than the width W_{S} between transversely spaced sprocket holes 432 of the film. Accordingly, the sprocket holes 432 do not travel over the opening 502 during movement of the film 220 (i.e. relative movement of the film and bridge 525). Rather, these holes 432 pass smoothly over the end portions 510 and 512 of the bridge, thereby reducing undesirable movement, vibration, and/or bouncing of the film during scanning by a scanning system.

Thus, it should be understood that the embodiments and examples have been chosen and described in order to best illustrate the principals of the invention and its practical applications to thereby enable one of ordinary skill in the art to best utilize the invention in various embodiments and with various modifications as are suited for particular uses contemplated. Accordingly, it is intended that the scope of the invention be defined by the claims appended hereto.

What is claimed is:

1. A film bridge for a film scanning system, comprising:
a first bridge member having a film facing surface to support photographic film moving relative to the bridge;
a second bridge member having a film facing surface to support photographic film moving relative to the bridge, wherein the bridge members are spaced so as to define an opening between the bridge members for passing radiation through film traveling over the film facing surfaces; and
a material applied to the film facing surface of at least one of said bridge members.

2. The film bridge as recited in claim 1, wherein the material has a length which is less than the width of the film between transversely spaced sprocket holes.

3. The film bridge as recited in claim 1, wherein the material comprises a coating.

4. The film bridge as recited in claim 1, wherein the bridge members comprise parallel elongated rigid strips, wherein each strip is curved in the film travel direction, and wherein the opening comprises an elongated slot defined between the strips.

5. The film bridge as recited in claim 1, wherein the bridge members comprise rollers.

6. The film bridge as recited in claim 1, wherein the material comprises a friction reducing material.

7. The film bridge as recited in claim 1, wherein the material comprises a coating including at least one of polytetrafluoroethylene, a diamond material, nickel, and anodize.

8. A film bridge for a film scanning system, comprising:
a first film roller positioned substantially orthogonally to a film travel direction and having a film facing surface to support photographic film moving relative to the film bridge;
a second film roller positioned substantially orthogonally to the film travel direction and having a film facing surface to support photographic film moving relative to the film bridge, wherein the first and second film rollers are spaced in the film travel direction so as to define an opening between the rollers for applying radiation to film traveling over the film facing surfaces of the rollers; and
a mounting assembly supporting the film rollers.

9. The film bridge as recited in claim 8, further comprising:
a first shaft provided through the center of the first roller and mounted to the mounting assembly such that the first roller is rotatable about the first shaft; and
a second shaft provided through the center of the second roller and mounted to the mounting assembly such that the second roller is rotatable about the second shaft.

10. The film bridge as recited in claim 8, wherein each roller has a length which is less than or equal to the width of the film between the film sprocket holes, such that sprocket holes of film traveling over the rollers during operation do not contact the rollers.

11. The film bridge as recited in claim 8, wherein the spacing between the rollers is not an integer multiple of the longitudinal distance between film sprocket holes.

12. The film bridge as recited in claim 11, wherein the spacing between the rollers is a half multiple of the longitudinal distance between film sprocket holes.

13. The film bridge as recited in claim 11, wherein the spacing s between the rollers is related to the longitudinal distance d between film sprocket holes by the equation:
s=(i.5)(d)
wherein i is a positive integer.

14. A digital film processing system, comprising:
a source configured to apply radiation to developing film;
a sensor configured to sense radiation from developing film; and
a film bridge configured to support developing film without contacting the sprocket holes of the developing film, as the source applies radiation to developing film.

15. The digital film processing system as recited in claim 14, wherein the film bridge comprises a pair of spaced rollers defining an opening through which the radiation is applied to developing film.

16. The digital film processing system as recited in claim 14, wherein the rollers have a length less than or equal to the width of the film between the sprocket holes.

17. The digital film processing system as recited in claim 14, wherein the film bridge comprises a pair of parallel rigid strips defining a slot through which the radiation is applied to developing film.

18. The digital film processing system as recited in claim 17, wherein the film bridge comprises friction reducing material applied to at least one of said strips.

19. The digital film processing system as recited in claim 14, wherein the bridge comprises a pair of spaced side rollers configured to contact developing film near the film side edges.

20. The digital film processing system as recited in claim 19, wherein each side roller includes a guide wall to restrain lateral movement of the developing film.

21. The digital film processing system as recited in claim 19, wherein the spacing between the side rollers is greater than the width of film between sprocket holes.

22. The digital film processing system as recited in claim 14, wherein the digital film processing system is adapted to combine digital images created at multiple film development times to create a single enhanced image.

23. A film bridge for a digital film scanning system, comprising:
a first side roller configured to support a first side edge of photographic film during film scanning; and
a second side roller transversely spaced from said first side roller and configured to support a second side edge of photographic film during film scanning.

24. The film bridge as recited in claim 23, wherein each side roller includes a ledge configured to support an edge of the developing film.

25. The film bridge as recited in claim 24, wherein each ledge is configured to support an edge portion of film outward of the film sprocket holes.

26. The film bridge as recited in claim 23, wherein each side roller includes a guide wall to restrain lateral movement of the film.

27. The film bridge as recited in claim 23, wherein the spacing between the side rollers is greater than the width of photographic film between sprocket holes.

28. The film bridge as recited in claim 23, further comprising:
a radiation source positioned between the side rollers; and
a radiation sensor positioned between the side rollers.

29. A film bridge for a film scanning system, comprising:
a first bridge member having a film facing surface to support photographic film moving relative to the bridge;
a second bridge member having a film facing surface to support photographic film moving relative to the bridge, wherein the bridge members are spaced so as to define an opening between the bridge members for passing radiation through film traveling relative to the film facing surfaces;
wherein the bridge members are connected near their ends such that the opening has a defined length; and
wherein the length of the opening is less than the width between the sprocket holes of the film to be scanned.

30. The film bridge as recited in claim in claim 29, wherein the bridge members are elongated strips, wherein each strip is curved in the film travel direction, and wherein the opening comprises an elongated slot defined between the strips.
